(19) United States
(12) Patent Application Publication
(10) Pub. No.: US 2023/0331517 A1
(43) Pub. Date: Oct. 19, 2023

(54) ELEVATOR CONTROL

(71) Applicant: KONE Corporation, Helsinki (FI)

(72) Inventors: Juha Parviainen, Helsinki (FI); Antti Määttä, Helsinki (FI); Salih Boutadghart, Helsinki (FI); Krittika Varmann, Helsinki (FI)

(73) Assignee: KONE Corporation, Helsinki (FI)

(21) Appl. No.: 18/213,079

(22) Filed: Jun. 22, 2023

Related U.S. Application Data
(63) Continuation of application No. PCT/FI2021/050007, filed on Jan. 7, 2021.

(51) Int. Cl. B66B 5/00

(52) U.S. Cl. CPC B66B 5/0012; B66B 5/0018; B66B 5/0037

(57) ABSTRACT

A monitoring system for monitoring an operating status of an elevator of an elevator system including one or more elevators includes a passenger tracking portion arranged to determine passenger movement on one or more landings served by the elevator on basis of location indications received from a positioning system; and an elevator status analysis portion arranged to detect a failure in operation of the elevator on basis of the passenger movement determined for a monitoring period.

### TECHNICAL FIELD

The example and non-limiting embodiments of the present invention relate to detection of a failure in operation of an elevator.

### BACKGROUND

Reliable and predictable availability of elevator transport is an important aspect of a user experience pertaining to the quality of service provided by an elevator system. On the other hand, modern elevator systems and elevator cars are complicated high-tech products that include a number of components whose correct operation is required to ensure reliable and safe transport of elevator passengers. In order to ensure timely detection of possible faults in operation, an elevator system may be provided with one or more sensors for monitoring correct operation of one or more elevator components: a measurement carried out by such a sensor may serve to indicate a normal operational state of a monitored elevator component when the measurement indicates an expected value for the measured aspect of the monitored elevator component and, conversely, to indicate an abnormal operational state of the monitored elevator component when the measurement fails to indicate an expected value for the measured aspect of the monitored elevator component.

Such sensor-based monitoring techniques provided for actively monitoring predefined aspects of operation of elevator components may be considered to serve as primary indications of the operational status of the elevator system and they enable obtaining accurate technical information concerning operation of the monitored elevator components. On the other hand, such active monitoring is inherently limited to detect foreseen potential irregularities that may occur duet unexpected operation of the monitored elevator components, whereas unforeseen irregularities in operation of the monitored elevator components or irregularities in other aspects or of elevator operation may likewise lead to an abnormal operational state of the elevator system and, consequently, to unintended limitations in availability of the elevator system for passenger transport. Moreover, a malfunction of a sensor may also result in a scenario where the sensor-based monitoring technique fails to detect an abnormal operational state of the monitored component. Consequently, secondary indications of the operational status of the elevator system may be useful in capturing situations where the elevator is unintentionally unavailable for passenger transport due to a reason that cannot be captured using the sensors applied for monitoring predefined aspects of operation of predefined elevator components.

In related art, U.S. 4,800,386 A discloses a method of and apparatus for counting objects present within a predetermined area, by detecting acceleration and deceleration of the objects employ at least one Doppler radar to sense the movements of the objects by monitoring the Doppler frequencies of signals reflected from the objects, amplifying the Doppler signal reflected from each of the objects to provide an amplified signal, effecting an automatic gain control of the amplified signal to provide a signal of substantially constant strength independent of the distance and size of the respective object, detecting a frequency variation of the constant strength signal as an indication of change in the speed of movement of a respective one of the objects, determining whether the constant strength signal represents an acceleration or deceleration of the respective object, and correspondingly modifying a count representing the number of the objects in the predetermined area.

### SUMMARY

It is an object of the present invention to provide a technique that enables detecting of a failure in elevator operation.

According to an example embodiment, a monitoring system for monitoring operating status of an elevator of an elevator system comprising one or more elevators is provided, the monitoring system comprising: a passenger tracking portion arranged to determine passenger movement on one or more landings served by said elevator on basis of location indications received from a positioning system; and an elevator status analysis portion arranged to detect a failure in operation of said elevator on basis of the passenger movement determined for a monitoring period.

According to another example embodiment, a method for monitoring operating status of an elevator of an elevator system comprising one or more elevators is provided, the method comprising: determining passenger movement on one or more landings served by said elevator on basis of location indications received from a positioning system; and detecting a failure in operation of said elevator on basis of the passenger movement determined for a monitoring period.

According to another example embodiment, a computer program for monitoring operating status of an elevator of an elevator system comprising one or more elevators is provided, the computer program comprising computer readable program code configured to cause performing at least the method according to the example embodiment described in the foregoing when said program code is executed on one or more computing apparatuses.

The computer program according to the above-described example embodiment may be embodied on a volatile or a non-volatile computer-readable record medium, for example as a computer program product comprising at least one computer readable non-transitory medium having the program code stored thereon, which, when executed by one or more computing apparatuses, causes the computing apparatuses at least to perform the method according to the example embodiment described in the foregoing.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

Some features of the invention are set forth in the appended claims. Aspects of the invention, however, both as to its construction and its method of operation, together with additional objects and advantages thereof, will be best understood from the following description of some example embodiments when read in connection with the accompanying drawings.

### BRIEF DESCRIPTION OF FIGURES

The embodiments of the invention are illustrated by way of example, and not by way of limitation, in the figures of the accompanying drawings, where

FIG. 1 illustrates a block diagram of some logical elements of an elevator system according to an example;

FIG. 2A illustrates a passenger track on a landing of an elevator system according to an example;

FIG. 2B illustrates a passenger track on a landing of an elevator system according to an example;

FIG. 2C illustrates a passenger track on a landing of an elevator system according to an example;

FIG. 3 illustrates a passenger track on a landing of an elevator system according to an example;

FIG. 4 illustrates a method according to an example, and

FIG. 5 illustrates a block diagram of some components of an apparatus according to an example.

### DESCRIPTION OF SOME EMBODIMENTS

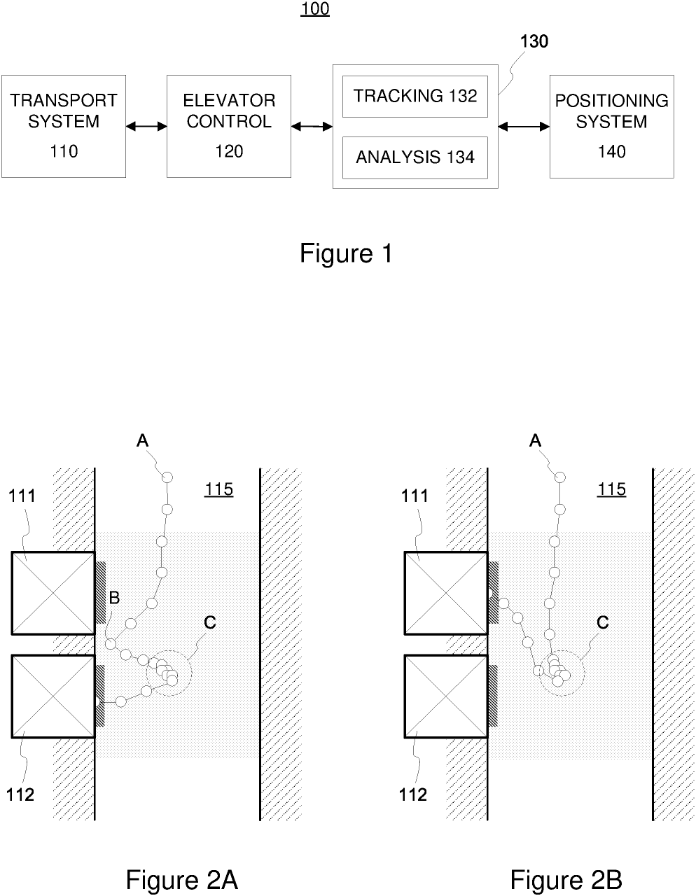

FIG. 1 illustrates a block diagram of some logical elements of an elevator system 100 according to an example. The elevator system 100 is shown in the example FIG. 1 with an elevator transport system 110 comprising one or more elevators for transporting passengers and an elevator controller 120 for controlling movement of the one or more elevators in accordance with transport requests received from passengers of the elevator system 100 e.g. via call giving devices arranged in elevator landings and/or via user devices that enable communicating with the elevator controller 120 for placement of transport requests.

Along the lines described in the foregoing, the elevator transport system 110 comprises one or more elevators arranged for transporting one or more passengers. Typically, the elevator transport system 110 is installed in a building, which may be residential building, an office building, a public building (such as a library, museum, a sports venue, a station of public transportation, ...), etc. Alternatively, the elevator transport system 110 may be installed to serve a location that is not strictly a building, such as an underground station of public transportation or another venue or place of interest that is offset from the ground level. Regardless of the usage environment of the elevator transport system 110, without losing generality the elevator may be considered to serve for transporting passengers between two or more floors or levels, where in each floor/level the area or location for entering or exiting the elevator car(s) may be referred to as a respective landing or landing area of the elevator system 100. The elevator transport system 110 is operated under control of the elevator control system 120.

In context of the present disclosure, an aspect of interest in relation to the elevator transport system 110 is the movement of passengers in the landings of the elevator system 100 and, consequently, any aspects related to the structure and operation of the one or more elevators of the elevator transport system 110 and/or those of the elevator control system 120 for transporting passengers between two or more landings of the elevator system 100 may be provided using techniques known in the art and, consequently, any details pertaining to their structure and operation are described herein only to extent they are necessary for describing examples that pertain to tracking movement of the passengers in the landings, to the landings and/or from the landings. The elevator system 100 may further comprise a monitoring system 130 for monitoring operating status of one or more elevators of the elevator system 100. The monitoring system 130 may rely on monitoring movement of one or more passengers in the one or more landings of the elevator system 100 on basis of location indications received from a monitoring system 140 and detecting a possible failure in operation of one of the one or more elevators on basis of passenger movement in the one or more landings. In this regard, the monitoring system 130 may comprise or it may be communicatively coupled to the positioning system 140 that serves to determine respective locations of one or more passengers in at least in the one or more landings of the elevator system 100. In particular, the monitoring system 130 may be applicable for tracking passenger locations and/or passenger movement in the one or more landings, from the one or more landings and/or to the one or more landings.

In an example, the positioning system 140 may comprise an indoor positioning system known in the art, arranged to determine respective positions of the one or more passengers in the one or more landings of the elevator system 100. In this regard, the indoor positioning system may rely on mobile devices (such as mobile phones or tablet computers) carried by the passengers e.g. via using infrastructure installed in the one or more landings to determine respective positions of the mobile devices over time based on radio signals (e.g. Wi-Fi or Bluetooth signals) originating from their radio transceivers. As another example, additionally or alternatively, the positioning system 140 may rely on motion sensors arranged in the landings of the elevator system 100. In this regard, the positing may rely on suitable motion detection technique known in the art, including passive motion detection (such as one based passive infrared sensor (PIR) or analysis of (video) images) or active motion detection (such as one based on transmission and reception of acoustics signals or microwave signals).

Regardless of the manner of embodying the positioning system 140, the output from the positioning system 140 comprises respective location indications for the one or more passengers. Each location indication may include or may be provided together with an identification of the passengers to which the respective location indication pertains. In this regard, the identification may identify the passenger in the framework of the monitoring system 130 without disclosing the actual identity of the passenger, e.g. such that the identification includes or is derived from an identifier (e.g. an address) received in radio signals originating from the mobile device carried by the respective passenger.

The monitoring system 130 may comprise a passenger tracking portion 132 for determining passenger movement of a plurality of passengers on the one or more landings of the elevator system 100 on basis of the location indications received from the positioning system 140 and an elevator status analysis portion 134 for detecting a failure in operation of the one or more elevators on basis of passenger movement determined for a monitoring period. In this regard, the monitoring system 130 has the knowledge of the respective locations of the one or more elevators with respect to the one or more landings of the elevator system 100, thereby enabling analysis of passenger movement with respect to the one or more elevators based on the location indications obtained from the positioning system 140. The monitoring system 130 may be operational substantially continuously, whereas an analysis that pertains to movement of individual passengers is carried out via usage of an analysis window having a duration defined by the monitoring period. Hence, according to an example, the analysis of passenger movement may be carried out in time segments having the duration defined by the monitoring period. Duration of the monitoring period may be selected according to circumstances, for example depending on the size of the landings, on the number of elevators in the elevator system 100, and/or on the expected amount of passengers moving in the one or more landings. In a non-limiting example, the duration of the monitoring period may be a predefined value chosen from a range from one minute to a fifteen minutes, e.g. 3 minutes.

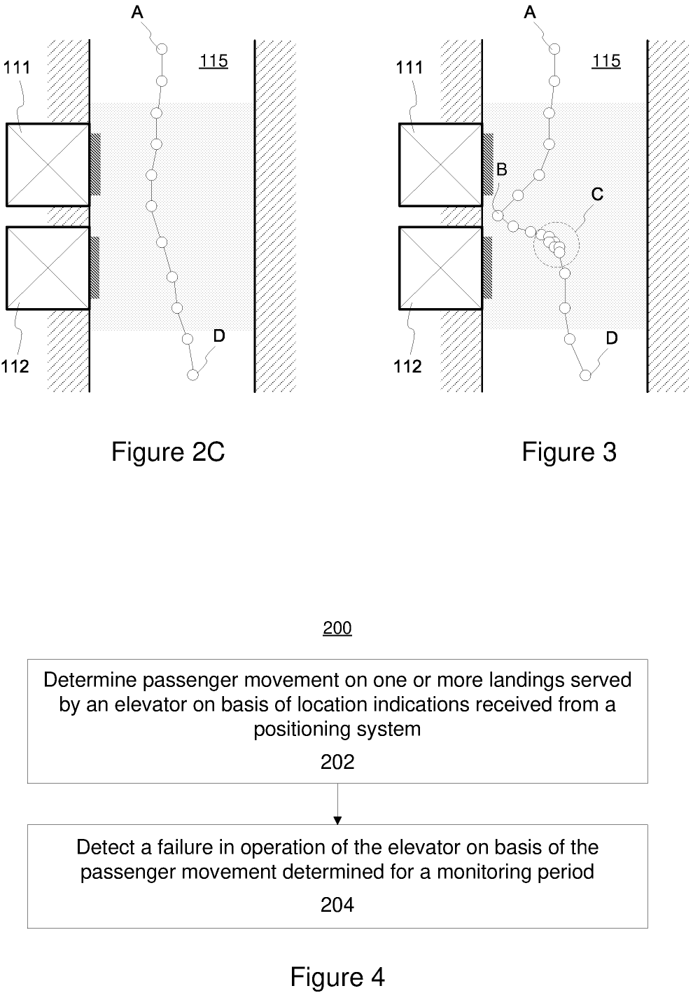

Before describing operation of the monitoring system 130 in further detail, non-limiting illustrative examples of passenger movement on the one or more landings of the elevator system 100 are provided. As an example in this regard, FIG. 2A schematically illustrates a landing 115 that enables accessing elevators 111 and 112 of the elevator system 100. Therein, movement of a certain passenger is illustrated by a passenger track formed by a sequence of small circles where adjacent circles are connected to each other by respective lines, where the circles represent respective location indications obtained for the certain passenger. In the example of FIG. 2A, the passenger track represents the certain passenger arriving at the landing in a location A, proceeding to a location B to place a transport request for the elevators 111 and 112 via operating the call giving device provided in the landing 115, proceeding further to a group of locations C to wait for the one of elevators 111, 112 to arrive at the landing 115, and proceeding still further to the elevator 111, 112 that is the first arrive at the landing 115, which in this example is the elevator 112.

FIG. 2B illustrates another example as a variation of the example of FIG. 2A, where the certain passenger proceeds from the location A to the group of locations C to wait for one of the elevators 111, 112 to arrive at the landing 115 before proceeding to enter the elevator 111, 112 that is the first to arrive at the landing 115, which in this example is the elevator 111. In a variation of the example of FIG. 2B, the certain passenger may proceed directly from the location A to the elevator 111. A situation described via examples that refer to FIG. 2B may arise, for example, when another passenger has already placed a transport request for the elevator 111 before the certain passenger arriving at the landing 115.

The passenger tracks described with examples that refer to FIGS. 2A and 2B serve as non-limiting examples of passenger movement on the landing 115 in a situation where the certain passenger proceeds to the landing 115 with the intent to use one of the elevators 111, 112 and proceeds to one of the elevators 111, 112 once it arrives at the landing 115. Consequently, in a situation where the elevators 111, 112 are both functioning normally, the passenger movement observed over the monitoring period can be expected to show passenger flows leading to both elevators 111, 112. On the other hand, in case a first one of the elevators 111, 112 exhibits a failure in its operation (due to technical malfunction or otherwise), the passenger flow can be expected to lead to the other one of the elevators 111, 112, either predominantly or even exclusively, depending on the extent and type of the failure pertaining to the first one of the elevators 111, 112.

While the examples described with references to passengers entering one of the elevators 111, 112, similar considerations with respect to a possible failure in operation of the first one of the elevators 111, 112 apply to passenger movement from the elevators 111, 112 to the landing 115 as well, mutatis mutandis: In case both elevators 111, 112 are both functioning normally, the passenger movement observed over the monitoring period can be expected to show passenger flows originating from both elevators 111, 112, whereas in case the first one of the elevators 111, 112 exhibits a failure in its operation, the passenger flow from the elevators 111, 112 to the landing 115 predominantly or even exclusively originates from the other one of the elevators 111, 112.

FIG. 2C illustrates a passenger track that serves as a further non-limiting example of passenger movement on the landing 115. In this example, the certain passenger proceeds from the location A to a location D through the landing 115, thereby representing a situation where the certain passenger proceeds to the landing 115 without an intent use the elevators 111, 112. As a key difference to the passenger movement on the landing 115 where a passenger intends to use the elevator 111 (apart from not leading to either of the elevators 111, 112), the passenger track according to the example of FIG. 2C typically indicates shorter residence time within the landing 115 due to the passenger not standing by on the landing 115 (as in the examples illustrated in FIGS. 2A and 2B) to wait for one of the elevators 111, 112 to arrive.

FIG. 3 illustrates further example of a passenger track as a variation of the passenger track shown in FIG. 2A, which serves as a non-limiting example of passenger movement on the landing 115 in a situation where the certain passenger proceeds from the location A via the location B to the group of locations C to wait for one of the elevators 111, 112 to arrive but after having waited for a while for one of the elevators 111, 112 to arrive, instead of entering one of the elevators 111, 112 the certain passenger moves on to the location F and onwards from the landing 115 e.g. to find another means of transportation to his/her destination floor, such as a further elevator, an escalator, stairs, etc. In a variation of this example, as in the example of FIG. 2B, the certain passenger may proceed from the location A to the group of locations C to wait for one of the elevators 111, 112 to arrive at the landing 115. In the examples pertaining to FIG. 3, a key difference to the passenger movement on the landing according to the examples pertaining to FIGS. 2A and 2B is that the passenger track according to the example of FIG. 3 does not lead to either of the elevators 111, 112 whereas a key difference to the passenger movement on the landing 115 according to the example pertaining to FIG. 2C is a longer residence time within the landing 115.

Hence, in the non-limiting examples pertaining to FIG. 3 represent a situation where where the certain passenger proceeds to the landing 115 with the intent to use one of the elevators 111, 112 but due to a failure in operation of both elevators 111, 112 the certain passenger does not proceed to either of the elevators 111, 112 but exits the landing. Consequently, in such a situation the passenger movement observed over the monitoring period can be expected to show a reduced or missing passenger flow to any of the elevators 111, 112, depending on the extent of the failure pertaining to the elevators 111, 112. Along similar lines, a failure in operation of both elevators 111, 112 results in a reduced or missing passenger flow from any of the elevators 111, 112 to the landing 115.

Referring now back to operation of the monitoring system 130, with knowledge of the passenger locations on the one or more landings of the elevator system 100, the passenger tracking portion 132 is able to derive information that is descriptive of the movement of the one or more passengers on the one or more landings (with respect to the one or more elevators), thereby enabling the elevator status analysis portion 134 to separately monitor passenger flows with respect to the one or more elevators on the one or more landings and, consequently, to detect a possible failure in operation of any of the one or more elevators of the elevator system 100 in any of the one or more landings. Hence, in a situation where the passenger flows are monitored (separately) on a plurality of (e.g. two or more) landings of the elevator system 100, the elevator status analysis portion 134 is able to detect possible failure in respective operation of one or more elevators of the elevator system 100 separately for the plurality of landings, thereby enabling detection of a failure that pertains only to a single one of the plurality of landings and/or that does not pertain to all landings.

According to a first exemplifying scenario, the monitoring system 130 may estimate the passenger flows directly on basis of passenger locations obtained from the monitoring system 140. In this regard, the passenger tracking portion 132 may record the respective location indications obtained from the positioning system at predefined time intervals (e.g. at a predefined ‘sampling rate’), where a suitable time interval may be e.g. in a range of a few tenths of a second to a few seconds, for example one second. Consequently, the passenger tracking portion 132 may determine, based on the location indications recorded therein, the number of passengers observed in a certain landing in general and the number of passengers observed to enter a given elevator of the elevator system 100 from the certain landing during the monitoring period. As an example in this regard, the passenger tracking portion 132 may determine the number of passengers observed to enter or exit a given elevator of the elevator system 100 at the certain landing by observing the number of passengers in an entry area assigned to the given elevator on the certain landing. The entry area assigned to the given elevator comprises a predefined sub-area of the certain landing that is adjacent to a landing door of the given elevator on the certain landing. The entry area typically comprises a sub-area that covers the width of the landing door and extends only a relatively short distance (in a range from a few tens of centimeters to one meter) away from the landing door, thereby constituting an area that is infrequently occupied by passengers other than those entering or exiting the given elevator. The illustrations of FIGS. 2A, 2B, 2C and 3 show examples of respective entry areas assigned to elevators 111, 112 as dark grey rectangles adjacent to the respective elevators 111, 112.

Consequently, the elevator status analysis portion 134 may detect a failure in operation of the given elevator on basis of an amount of passengers observed entering or exiting the given elevator at the certain landing. As an example in this regard, the failure detection may involve detecting a failure in operation of the given elevator in response to the number of passengers observed entering or exiting the given elevator at the certain landing in relation to the overall number of passengers observed in the certain landing failing to exceed a first predefined threshold value. The first threshold may be set differently for different landings of the elevator system 100 to account for different amount of through traffic thereon and/or for different number of elevators accessibly thereat (e.g. the ground floor vs. upper floors of an office building or a shopping mall). In an example, a failure detected via usage of the first threshold value may be considered valid only in case the overall number of passengers observed in the certain landing exceeds a predefined minimum number in order to avoid false failure detections when the overall number of passengers observed in the certain landing is low.

In this regard, the threshold value may be set to zero (e.g. 0 %) or to a value that is only slightly larger than zero to ensure detecting a failure only in case there is substantially no movement to and/or from the given elevator at the certain landing. In another example, the first threshold value may be set to a (non-zero) value that indicates lower than normal passenger flow to and/or from the given elevator at the certain landing. In this regard, the first threshold value may comprise a predefined percentage, which may depend on the number of elevators accessible from the certain landing and/or on (an expected amount of) passenger movement through the certain landing without an intent to enter an elevator at the certain landing. As an example, in case the given elevator is the only elevator accessible from the certain landing and approximately P % of passenger movement therein is assumed to be through-traffic without an intent to use the given elevator, the expected percentage of passengers moving on the certain landing due to entry to or exit from the given elevator is (100 - P) % and, consequently, the threshold value may be set to suitable value that is smaller than (100 - P) %. In a variation of this example, assuming that there is another elevator accessible from the certain landing, the expected percentage of passengers using or having an intent to use either of the elevators accessible therefrom may be distributed evenly to the two elevators and, consequently, the threshold value may be set to suitable value that is smaller than (100 - P) / 2 %.

In another example pertaining to failure detection on basis of an amount of passengers observed entering or exiting the given elevator at the certain landing, the failure detection may involve detecting a failure in operation of the given elevator in response to the number of passengers observed entering or exiting the given elevator at the certain landing failing to exceed a second predefined threshold value. As an example, the second threshold value may be zero, resulting in a failure only in a situation where no passengers are observed to enter or exit the given elevator at the certain landing. As in case of the failure condition relying on the first threshold value, also in this example the detection of a failure may be considered valid only in case the overall number of passengers observed in the certain landing exceeds the predefined minimum number. The failure condition relying on the second threshold value may be applied on its own or together with the failure condition that relies on the first threshold value (such that at least one of the failure conditions or such that both of the failure conditions need to be met in order to indicate the failure in operation of the given elevator).

According to a second exemplifying scenario, the monitoring system 130 may estimate the passenger flow by following respective movement of individual passengers on the one or more landings of the elevator system 100 via respective passenger tracks derivable on basis of location indications obtained from the positioning system 140. Along the lines described in the foregoing for the first scenario, the passenger tracking portion 132 may record the respective location indications obtained from the positioning system at predefined time intervals and arrange the respective location indications pertaining to the one or more passengers into respective time series of location indications. The time series of location indications pertaining to the certain passenger may be referred to as a passenger track of the certain passenger. Hence, each passenger track serves to represent movement of the respective passenger on the respective landing of the elevator system 100 and hence enables tracking the movement of the respective passenger on the respective landing.

Consequently, in the second scenario the elevator status analysis portion 134 may carry out a passenger track analysis in order to detect a possible failure pertaining to a given elevator on a certain landing of the elevator system 100 on basis of the passenger tracks derived for the certain landing of the elevator system 100. As an example in this regard, the elevator status analysis portion 134 may detect a failure in operation of the given elevator on basis of an amount of passenger tracks that terminate at the given elevator at the certain landing, e.g. such that a failure in operation of the given elevator is detected in response to the number of passenger tracks that terminate at the given elevator at the certain landing in relation to the number of reference passenger tracks derived for the certain landing failing to exceed a third predefined threshold value. In case the passenger track analysis considers all passenger tracks terminating at the given elevator at the certain landing with the reference passenger tracks including all passenger tracks derived for the certain landing, the third threshold value may be set or selected in a manner similar to that described in the foregoing for the first threshold value, mutatis mutandis.

Instead of considering all passenger tracks in the passenger track analysis, only a limited subset of passenger tracks terminating at the given elevator at the certain landing may be considered. In this regard, the passenger track analysis may consider only those passenger tracks that represent passenger movement originating from the given elevator, only those passenger tracks that represent passenger movement leading to the given elevator, or both the passenger tracks that represent passenger movement originating from the given elevator and the passenger tracks that represent passenger movement leading to the given elevator.

Along similar lines, instead of considering all passenger tracks derived for the certain landing as the reference passenger tracks, a limited subset of passenger tracks derived for the certain landing may be applied as the reference. As examples in this regard, the reference passenger tracks may comprise only those passenger tracks that terminate at one of the elevators accessible at the certain landing, only those passenger tracks that do not terminate at any of the of the elevators accessible at the certain landing, only those passenger tracks that terminate at an elevator other than the given elevator, only those passenger tracks that involve residence time in the certain landing exceeding a predefined waiting time threshold. In the latter example, the waiting time threshold may be set, for example, based on the number of elevators accessible at the certain landing and/or on the size of the certain landing and it may be, for example, in a range from ten seconds to a few minutes, e.g. two minutes. Such an approach may serve to exclude passenger tracks that represent passenger traffic through the certain landing from consideration by the passenger track analysis (while possibly also excluding passenger tracks that represent passenger movement originating from elevators accessible at the certain landing), thereby focusing the passenger track analysis to passenger movement that represents passengers standing by on the certain landing to wait for one of the elevators accessible thereat to arrive.

The selection with respect to types of passenger tracks terminating at the given elevator (e.g. ones originating therefrom, ones leading thereto, or both) and the reference passenger tracks to be considered in the passenger track analysis enables observing a desired characteristics of the passenger flow (or lack thereof) to the given elevator at the certain landing, thereby allowing for tailoring the monitoring system 130 to account for respective characteristics of the elevator system 100 and the passenger flows on its one or more landings. In this regard, the selection may be made the same for different landings of the elevator system 100 or different selections may be made across the landings of the elevator system 100. Consequently, the third threshold value needs to be set in consideration of the types of passenger tracks terminating at the given elevator and the reference passenger tracks to be considered in the passenger track analysis.

In a further example in the framework of the second scenario, the monitoring system 130 may only consider passenger locations that are within a predefined waiting area assigned to the given elevator on the certain landing, where the waiting area may comprise a predefined sub-area of the certain landing, which sub-area is adjacent to the given elevator. The illustrations of FIGS. 2A, 2B, 2C and 3 show examples of a waiting area assigned to elevators 111, 112 as the light grey rectangle covering the sub-area of the landing 115 in front of the elevators 111, 112. Such limitation of passenger movement under consideration may be accomplished, for example, by the passenger tracking portion 132 considering only those passenger locations that are within the waiting area in derivation of the passenger tracks or by the elevator status analysis portion 134 considering only those parts of the passenger tracks that represent passenger movement within the waiting area. Such application of the waiting area may serve to direct the failure detection to concentrate such passenger tracks that have a higher likelihood of representing passenger movement to or from the elevators accessible from the certain landing (while excluding passenger tracks that represent movement through the certain landing without an intent to enter an elevator in the certain landing).

Instead of or in addition to the passenger track analysis relying on the number of passenger tracks terminating at the given elevator in relation to the number of reference passenger tracks, the failure detection may detect a failure in operation of the given elevator in response to the number of passenger tracks terminating at the given elevator failing to exceed a fourth predefined threshold value. As an example, the fourth threshold value may be zero, resulting in a failure only in a situation where no passengers are observed to enter or exit the given elevator at the certain landing (depending on the types of passenger track terminating at the given elevator under consideration). In this regard, the considerations provided in the foregoing for the second threshold value apply, mutatis mutandis.

In case the elevator status analysis portion 134 detects a failure in operation of the given elevator, the monitoring system 130 (e.g. the status analysis portion 134) may proceed to issue a notification or alert regarding the detected failure. The notification or alert may include an identification of the elevator found to have a failure in its operation and it may further comprise an indication of the landing(s) to which the detected failure pertains. The notification or alert may be transmitted to the elevator controller 120, which may invoke predefined action in response to receiving such a notification or alert. An example of such a predefined action includes triggering a service request for a technician to inspect the operational state of the elevator(s) of the elevator system 100. In this regard, at least some of the elevators of the elevator system 100 may be provided with respective sensors arranged for monitoring certain aspects of operation of one or more components thereof, while the notification or alert originating from the monitoring system 130 may serve to provide complementary or secondary information regarding the operating status of the elevator system 100.

The operation described in the foregoing with references to the monitoring system 130 may be, alternatively, described as steps of a method. As an example in this regard, FIG. 4 depicts a flowchart illustrating a method 200, which may be carried out by the monitoring system 130, by the elevator controller 120, or by another component of the elevator system 100 or by a component coupled to the elevator system 100. The method 200 comprises determining passenger movement on one or more landings served by an elevator on basis of location indications received from a positioning system, as indicated in block 202, and detecting a failure in operation of said elevator on basis of the passenger movement determined for a monitoring period, as indicated in block 204. Respective operations described with references to blocks 202 and 204 pertaining to the method 200 may be implemented, varied and/or complemented in a number of ways, for example as described with references to the monitoring system 130 in the foregoing and/or in the following.

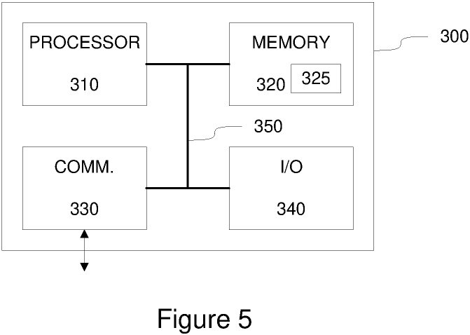

FIG. 5 illustrates a block diagram of some components of an apparatus 300 that may be employed to implement operations described in the foregoing with references to the monitoring system 130. The apparatus 300 comprises a processor 310 and a memory 320. The memory 320 may store data and computer program code 325. The apparatus 300 may further comprise communication means 330 for wired or wireless communication with other apparatuses and/or user I/O (input/output) components 340 that may be arranged, together with the processor 310 and a portion of the computer program code 325, to provide the user interface for receiving input from a user and/or providing output to the user. In particular, the user I/O components may include user input means, such as one or more keys or buttons, a keyboard, a touchscreen or a touchpad, etc. The user I/O components may include output means, such as a display or a touchscreen. The components of the apparatus 300 are communicatively coupled to each other via a bus 350 that enables transfer of data and control information between the components.

The memory 320 and a portion of the computer program code 325 stored therein may be further arranged, with the processor 310, to cause the apparatus 300 to perform at least some aspects of operation of the monitoring system 130 described in the foregoing. The processor 310 is configured to read from and write to the memory 320. Although the processor 310 is depicted as a respective single component, it may be implemented as respective one or more separate processing components. Similarly, although the memory 320 is depicted as a respective single component, it may be implemented as respective one or more separate components, some or all of which may be integrated/removable and/or may provide permanent / semi-permanent/ dynamic/cached storage.

The computer program code 325 may comprise computer-executable instructions that implement at least some aspects of operation of the monitoring system 130 described in the foregoing when loaded into the processor 310. As an example, the computer program code 325 may include a computer program consisting of one or more sequences of one or more instructions. The processor 310 is able to load and execute the computer program by reading the one or more sequences of one or more instructions included therein from the memory 320. The one or more sequences of one or more instructions may be configured to, when executed by the processor 310, cause the apparatus 300 to perform at least some aspects of operation of the monitoring system 130 described in the foregoing. Hence, the apparatus 300 may comprise at least one processor 310 and at least one memory 320 including the computer program code 325 for one or more programs, the at least one memory 320 and the computer program code 325 configured to, with the at least one processor 310, cause the apparatus 300 to perform at least some aspects of operation of the monitoring system 130 described in the foregoing.

The computer program code 325 may be provided e.g. a computer program product comprising at least one computer-readable non-transitory medium having the computer program code 325 stored thereon, which computer program code 325, when executed by the processor 310 causes the apparatus 300 to perform at least some aspects of operation of the monitoring system 130 described in the foregoing. The computer-readable non-transitory medium may comprise a memory device or a record medium such as a CD-ROM, a DVD, a Blu-ray disc or another article of manufacture that tangibly embodies the computer program. As another example, the computer program may be provided as a signal configured to reliably transfer the computer program.

Reference(s) to a processor herein should not be understood to encompass only programmable processors, but also dedicated circuits such as field-programmable gate arrays (FPGA), application specific circuits (ASIC), signal processors, etc. Features described in the preceding description may be used in combinations other than the combinations explicitly described.

1. A monitoring system for monitoring an operating status of an elevator of an elevator system comprising one or more elevators, the monitoring system comprising:
a passenger tracking portion arranged to determine passenger movement on one or more landings served by said elevator on basis of location indications received from a positioning system; and
an elevator status analysis portion arranged to detect a failure in operation of said elevator on basis of the passenger movement determined for a monitoring period.

2. The monitoring system according to claim 1, wherein the elevator status analysis portion is arranged to detect a failure in operation of said elevator on basis of an amount of passengers observed entering or exiting said elevator at the respective landing.

3. The monitoring system according to claim 2, wherein the elevator status analysis portion is arranged to detect a failure in operation of said elevator in response to the number of passengers observed entering or exiting said elevator at the respective landingin relation to the number of passengers observed on the respective landing failing to exceed a predefined threshold value.

4. The monitoring system according to claim 2, wherein the elevator status analysis portion is arranged to determine the number of passengers entering or exiting said elevator as the number of passengers observed in an entry area assigned to said elevator on the respective landing, and
wherein the entry area comprises a predefined area adjacent to a landing door of said elevator on the respective landing.

5. The monitoring systemaccording to claim 1, wherein the passenger tracking portionis arranged to derive a respective passenger track for a plurality of passengers on basis of the location indications received from a positioning system, wherein each passenger track represents movement of a respective one of said plurality of passengers on one of said one or more landings, and
wherein the elevator status analysis portionis arranged to detect a failure in operation of said elevator on basis of an amount of passenger tracks that terminate at said elevator on the respective landing.

6. The monitoring systemaccording to claim 5, wherein the elevator status analysis portionis arranged to detect a failure in operation of said elevator in response to the number of passenger tracks that terminate at said elevator on the respective landingin relation to the number of reference passenger tracks derived for the respective landingfailing to exceed a predefined threshold value.

7. The monitoring system according to claim 6, wherein said passenger tracks that terminate at said elevator comprise one or both of the following:
passenger tracks that represent passenger movement originating from said elevator.
passenger tracks that represent passenger movement leading to said elevator.

8. The monitoring systemaccording to claim 6, wherein said reference passenger tracks comprise one of the following:
all passenger tracks derived for the respective landing,
all passenger tracks that terminate in one of the elevators accessible at the respective landing,
all passenger tracks that involve residence time in the respective landingthat exceeds a predefined waiting time threshold.

9. The monitoring system according to claim 1, wherein the passenger tracking portionis arranged to only consider locations that are within a respective waiting area assigned to said elevator on the respective landing, wherein the waiting area comprises a predefined sub-area of the respective landingthat is adjacent to said elevator.

10. The monitoring system according to claim 1, wherein the elevator status analysis portionis arranged to carry out the failure detection separately for a plurality of landings served by said elevator.

11. The monitoring system according to claim 1, wherein the elevator status analysis portion is arranged to issue a notification in response to detecting a failure in operation of said elevator.

12. An elevator systemcomprising:
an elevator transport system comprising one or more elevators; and
the monitoring systemaccording to claim 1.

13. A method for monitoring an operating status of an elevator of an elevator system comprising one or more elevators, the method comprising the steps of:
determining passenger movement on one or more landings served by said elevator on basis of location indications received from a positioning system; and
detecting a failure in operation of said elevator on basis of the passenger movement determined for a monitoring period.

14. The method according to claim 13, further comprising the step of detectinga failure in operation of said elevator on basis of an amount of passengers observed entering or exiting said elevator at the respective landing.

15. A computer program embodied on a non-transitory computer readable medium and comprising computer readable program code configured to cause performing of the method according to claim 13 when said program code is run on a computing apparatus.

16. The monitoring system according to claim 3, wherein the elevator status analysis portion is arranged to determine the number of passengers entering or exiting said elevator as the number of passengers observed in an entry area assigned to said elevator on the respective landing, and
wherein the entry area comprises a predefined area adjacent to a landing door of said elevator on the respective landing.

17. The monitoring system according to claim 7, wherein said reference passenger tracks comprise one of the following:
all passenger tracks derived for the respective landing,
all passenger tracks that terminate in one of the elevators accessible at the respective landing,
all passenger tracks that involve residence time in the respective landing that exceeds a predefined waiting time threshold.

18. The monitoring system according to claim 2, wherein the passenger tracking portion is arranged to only consider locations that are within a respective waiting area assigned to said elevator on the respective landing, wherein the waiting area comprises a predefined sub-area of the respective landing that is adjacent to said elevator.

19. The monitoring system according to claim 3, wherein the passenger tracking portion is arranged to only consider locations that are within a respective waiting area assigned to said elevator on the respective landing, wherein the waiting area comprises a predefined sub-area of the respective landing that is adjacent to said elevator.

20. The monitoring system according to claim 4, wherein the passenger tracking portion is arranged to only consider locations that are within a respective waiting area assigned to said elevator on the respective landing, wherein the waiting area comprises a predefined sub-area of the respective landing that is adjacent to said elevator.
